(19) United States
(12) Patent Application Publication
(10) Pub. No.: US 2010/0330964 A1
(43) Pub. Date: Dec. 30, 2010

(54) WIRELESS COMMUNICATION DEVICE FOR PROCESSING INCOMING CALLS ON-DEMAND WITH MULTIPLE PRE-RECORDED ANSWERING VOICES AND/OR PRE-DEFINED MESSAGES

(75) Inventors: Milly HL Chen, Taipei (TW); Rebecca LJ Chen, Taipei (TW); Cecelia YC Yu, Taipei (TW)

Correspondence Address: Kunzler Needham Massey & Thorpe, 8 EAST BROADWAY, SUITE 600, SALT LAKE CITY, UT, 84111, US

(73) Assignee: International Business Machines Corporation, Armonk, NY (US)

(21) Appl. No.: 12/823,883

(22) Filed: Jun. 25, 2010

(30) Foreign Application Priority Data
Jun. 30, 2009 (TW) 98122187

(51) Int. Cl. H04L 12/58

(52) U.S. Cl. 455/412.1

(57) ABSTRACT

Disclosed is a device for a wireless communication device for processing incoming calls on-demand with multiple pre-recorded answering voices and/or pre-defined messages. The device comprises a bus system, a memory connected to the bus, the memory comprising a set of incoming call response instructions, and a controller connected to the bus. The controller executes the set of incoming call response instructions, comprising: checking a scenario setting and a user preference; responding, if a caller of an incoming call is a priority caller defined in the user preference, with a pre-recorded answering voice and/or pre-defined message indicated by the user preference and corresponding to the scenario setting. The instructions may also include responding, if a caller of an incoming call is not a priority caller as defined in the user preference, with a standard or default pre-recorded answering voice and/or pre-defined message.

### CROSS-REFERENCE TO RELATED APPLICATIONS

This application claims priority of Taiwan Patent Application Serial No. 98122187 entitled “COMMUNICATION SERVER AND METHOD OF PROCESSING MESSAGES UTILIZING THE SERVER”, filed on Jun. 30, 2009.

### FIELD

The present invention relates generally to a field of processing incoming calls, and more particularly, to a device for a wireless communication device for processing incoming calls on-demand with multiple pre-recorded answering voices and/or pre-defined messages.

### BACKGROUND

### Description of the Related Art

In today's society, the use of wireless communication devices is becoming more and more popular and powerful. Wireless communication devices permit a user to communicate with others from almost any location on the Earth. Such devices typically include, but are not limited to, mobile communication device (e.g. cell-phones), Personal Digital Assistants (PDAs) or other wireless electronic devices.

In addition to conventional voice communication, wireless communication devices also provide features such as voicemail, voice messaging and automatic callback notification. When receiving an incoming call in conventional wireless communication devices, a user generally only has two options: 1) answer the call, and 2) reject the call, and/or let it go to a voicemail system—for example, the call may go to voicemail after a predetermined number of rings. The voicemail typically allows for only one voice message to be pre-recorded by the user, and all callers directed to a voicemail will hear that voice message. For example, the user may set up a voice message stating: “I am busy, and I will call you back later;” or “I am in a meeting right now, and I will call you back later.”

While the wireless revolution has increased the ability of individuals to communicate with others, there are times when a user of a wireless communication device is unavailable to take a call, or does not pre-record one general voice message suitable for different callers. The a user may be unavailable to take a call when, for example, she is in a public place (such as a movie theater, a restaurant or a meeting), or when it is inconvenient for the user to take a call (such as while the user is busy, driving a car on a highway, riding a motorcycle, or even when the user simply does not want to take a call). In these different instances when a user is unavailable, the user may wish to provide different callers with different, unique messages, or even real-time and dynamic messages. For example, the user may want the message to include information from a GPS module; that way, the location information or the estimated time to destination (such as the office) could be included in the message for callers. It is also desirable to provide messages for callers in a manner most cost-effective to the user.

There have been conventional techniques for storing a plurality of stored messages which can be selected for playing back to a caller of an incoming call. These voice messaging options are saved internally to the mobile communication device. This requires additional memory storage within the mobile communication device, which costs money and occupies valuable space within the wireless communication device. As wireless communication device becomes smaller and smaller, the allotted space within the wireless communications device must continually be more efficiently utilized. Further, with the price pressures affecting the consumer market, the ability to add functionality to a mobile communications device without adding hardware and incurring additional costs is desirable.

### BRIEF SUMMARY

Responsive to the above-mentioned issues in traditional techniques, several embodiments of the present invention are provided, such as a device, a method and a computer program product for automatically selecting an internet browser and providing a web service in order to improve one or many issues mentioned above.

According to an embodiment of the present invention, a device for a wireless communication device is provided for a user to define her/his preferred response message. When there is an incoming call and the user wants to route the call to a voicemail system instead of answering it, the user may use a specific pre-defined key to select a pre-defined message (or a pre-recorded voice message). Also, the user may pre-define a set of caller identities, so that the response to the incoming call is automatically associated with a pre-defined message according to the caller identity.

One aspect of an embodiment of the present invention discloses a device for wireless communication device for processing incoming calls on-demand with multiple pre-recorded answering voices and/or pre-defined messages. The device comprises a bus system, and a memory connected to the bus. The memory comprises an incoming call response instructions module and a controller connected to the bus. The controller executes the set of incoming call response instructions in the call response instructions module. The instructions comprise: checking a scenario setting and a user preference; responding, if the caller of an incoming call is a priority caller (as defined in the user preferences), with a pre-recorded answering voice and/or pre-defined message as indicated by the user preference corresponding to the scenario setting. The instructions may further comprise responding, if a caller of an incoming call is not a priority caller (as defined in the user preferences), with a standard or default pre-recorded answering voice and/or pre-defined message.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIGS. 1A and 1B respectively show a user interface and a block diagram of a device for wireless communication device for processing incoming calls on-demand with multiple pre-recorded voice messages (or SMS);

FIG. 2 is a flowchart illustrating a process of creating a user preference for each Auto-Reply voice message in an Auto-Reply Mode;

FIG. 3 is a flowchart illustrating a process of creating voice messages corresponding to user's inputs; and

FIG. 4 is a workflow diagram illustrating an embodiment of an incoming call response module of the device responding to an incoming call.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a server, a computer apparatus, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

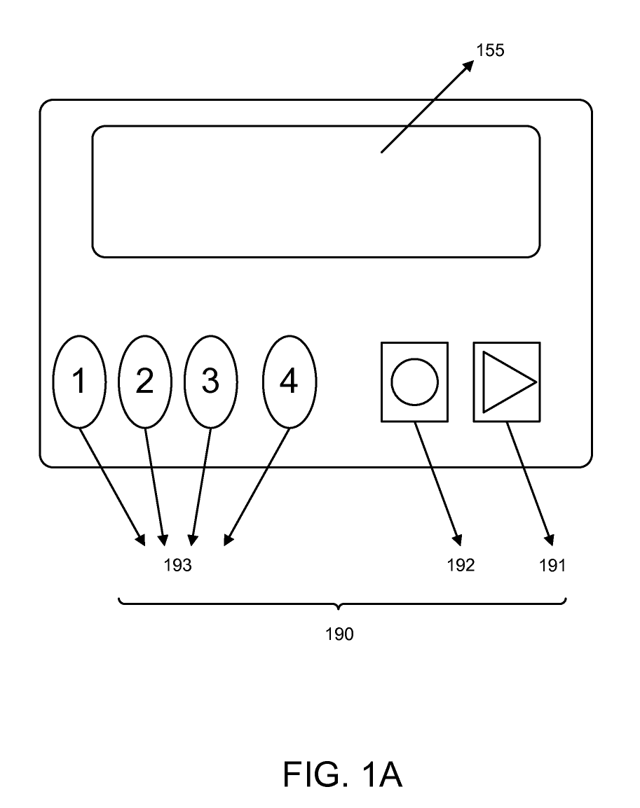

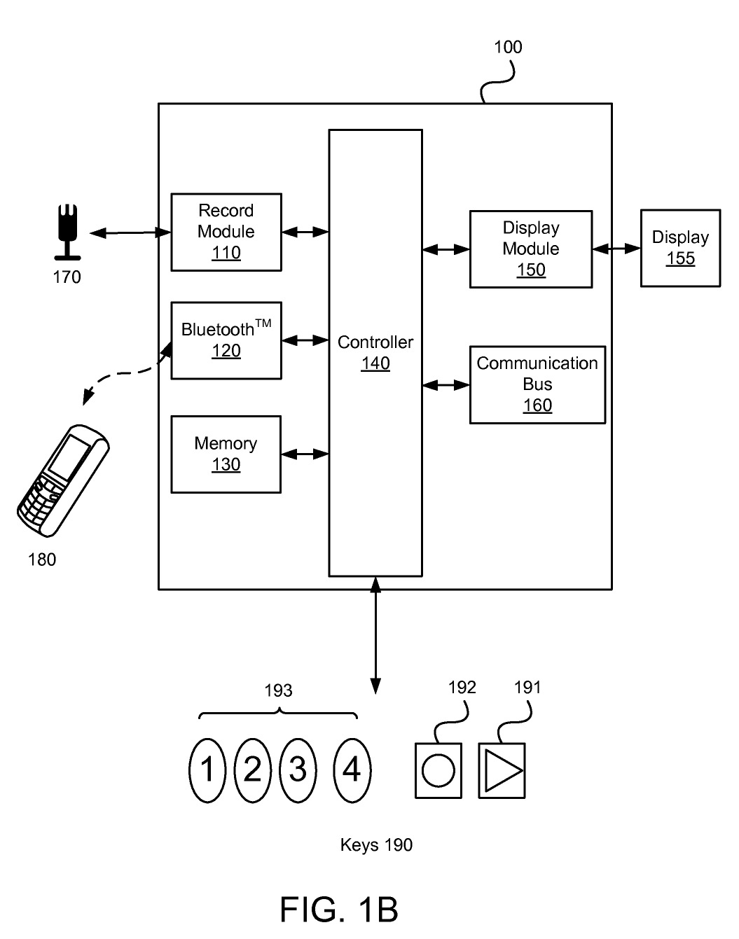

Referring now to FIG. 1A through FIG. 4, a system, devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIGS. 1A and 1B respectively show a user interface and a block diagram of a device for a wireless communication device for processing incoming calls on-demand with multiple pre-recorded voice messages, according to one embodiment of the present invention. The device 100 enables a user (e.g. car driver) to use a wireless communication device such as a cell-phone 180 located somewhere in or near the vicinity of the device 100 in a hands-free manner. The device 100 enables the user to control the operation of the cell-phone 180. In certain embodiments, the device 100 is a peripheral device. The wireless communication device 100 may be a Bluetooth™ enabled device. Through the use of Bluetooth™ communication technology, the device 100 and the cell-phone 180 wirelessly transmit signals between themselves to communicate with one another.

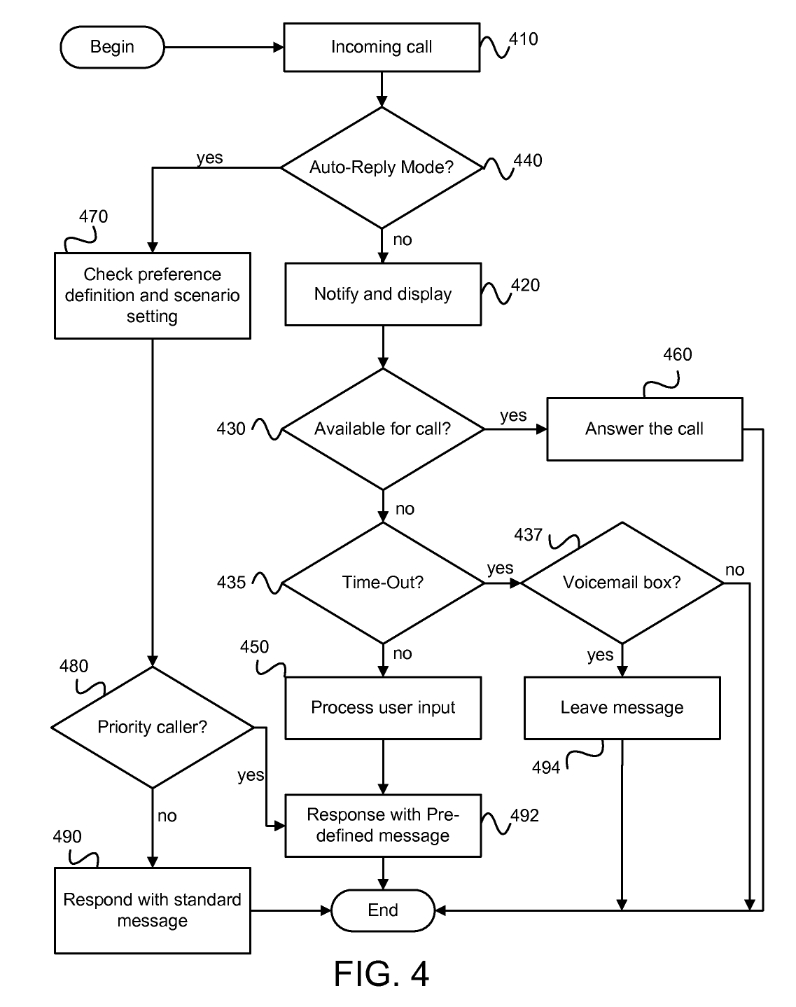

The device 100 includes a controller 140 which provides an incoming call response module to control the overall operation of the device 100. The incoming call response module will be described in more detail with reference to FIG. 4. The device 100 may further include a Bluetooth™ communications module 120 which wirelessly communicates with Bluetooth™ enabled devices such as cell-phone 180. The device 100 may be communicating with the wireless communication device 180 by any wireless technologies (such as GPRS, 3G, CDMA, CDMA 2000, W-CDMA, TD-SCDMA, Wi-Fi, WiMAX etc.).

The device 100 further includes a record module 110 for recording voice messages via a microphone 170 and for storing the messages into a memory 130. The record module 110 may be also used to create pre-defined short messages (SMS) such as short message service, which is a conventional technology and thus is omitted here for conciseness. FIG. 1A show a user interface of the device 100 according to one embodiment of the present invention. As illustrated, the device 100 further includes a set of keys 190. The set of keys include a play key 191 and a record key 192 for the user to directly play and record voice messages (and/or SMS). The set of keys 190 may further include four keys 193 for user to directly select a pre-recorded voice message (and/or SMS) for responding to different callers. The number of keys 193 is not limited to four keys disclosed in the embodiment of the present invention—more than four keys or less than four keys is acceptable.

The Memory 130 may also store personal information in a phonebook(s) which may also be stored in a phonebook of cell-phone 180. Such information may include a listing of names and associated telephone numbers. The device 100 also includes a display module 150 which is connected to a display such as an LCD display 155.

When there is an incoming call, the caller's identity information (such as name, phone number etc.) will be transmitted via wireless connection (e.g. Bluetooth™ communication technology) from the cell-phone (e.g. Bluetooth™ enabled devices) 180 to the device 100, which is located near the cell-phone 180. For example, if in a car, this device 100 could be embedded on the steering wheel, or embedded on the front panel like a Global Positioning System (GPS) for car, which is generally positioned on the front panel. The phone number or SMS of the incoming call may be displayed on the display 155. In the meantime, the user can click one of keys 193 on the device 100 to manually select one pre-recorded voice message (or SMS) to respond with. In accordance with the embodiment of the present invention, the user may also pre-define her/his preference(s) with respect to each caller, so that the device 100 can reply to the incoming call automatically with a pre-recorded voice message (or SMS) when the user switches to an Auto-Reply Mode. As illustrated in FIG. 1B, the controller 140 is also connected to a communication bus 160 in order to communicate with other devices around the device 100, and thus enables the device 100 to control the other devices, such as, for a car, the vehicle radio, or vehicle climate control.

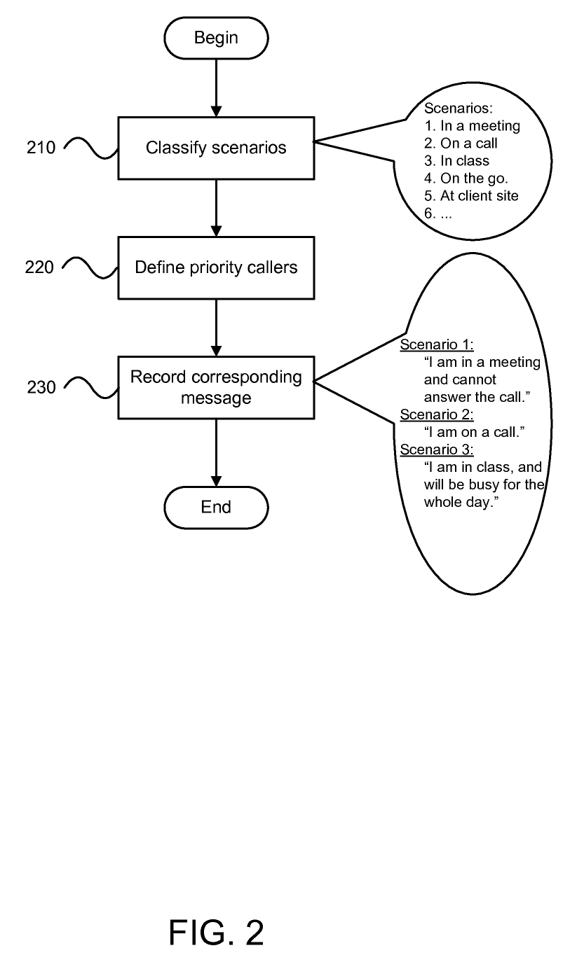

FIG. 2 is a flowchart illustrating a process of creating a user preference for each Auto-Reply voice message in an Auto-Reply Mode according to one embodiment of the present invention. In step 210, a user classifies different scenarios the user may encounter in order to establish a scenario setting. For example, as illustrated in FIG. 2, the scenarios may be as follows: (1) in a meeting; (2) on a call; (3) in class; (4) on the go; (5) at client site, etc. In step 220, the user will classify the callers (such as boss, friend or colleague) and define one priority caller or a set of priority callers based on the importance level of callers, depending upon the user's need. In step 230, for different scenarios, pre-recorded voice messages (and/or SMS) are associated with the one priority caller or the set of priority callers that are pre-recorded into the device 100. For example, for the scenario 1, the message, “I am in a meeting and cannot answer the call” will be pre-recorded for a friend. The message can be also set for any priority callers such as both a friend and a colleague, depending on the user's need. A pre-defined user preference or a set of user preferences will be set up accordingly.

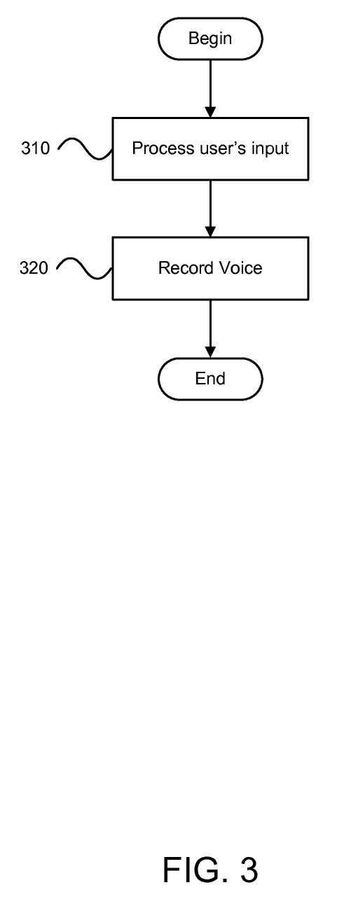

FIG. 3 is a flowchart illustrating a process of creating voice messages corresponding to user's inputs according to one embodiment of the present invention. In step 310, the user provides user inputs by setting different keys 193 on the device 100 for different user inputs. In step 320, the user then records different pre-recorded voice message (or SMS) in accordance with different keys 193.

FIG. 4 is a workflow diagram illustrating one embodiment of an incoming call response module of device 100 responding to an incoming call. When the wireless communication device 180 of a user (such as a cell-phone) receives an incoming call, the call will be automatically routed to the device 100 via the Bluetooth™ communications module 120 (step 410). If the device 100 is not set to an Auto-Reply Mode, the process proceeds to step 420.

In step 420, the device 100 will notify and display the number of the incoming call on the display 155. If the user is available to reply the call, he/she will answer the call directly (step 460). Otherwise, after a predetermined number of rings (step 435), the user will be directly routed to a voicemail system (step 437) for leaving a message by the caller (step 494). If the time-out of rings is not reached and the user clicks one of keys 193 on the device 100, the user's input represented by the clicked key will be processed (step 450), and then the pre-recorded voice message or SMS (as shown in FIG. 3) designated by the user's input will be used for responding to different callers (step 492).

If the device 100 is set to an Auto-Reply Mode, the process proceeds to step 470. The module will check the current scenario setting and user preference(s) of the user so as to determine whether the caller is a priority caller. If the caller belongs to a priority caller defined in the user preference(s), a pre-recorded answering voice and/or pre-defined message indicated by the user preference(s) and corresponding to the scenario setting will be used to respond to the caller (step 492). Otherwise, a standard or default pre-recorded answering voice and/or pre-defined message will be used to respond (step 490).

The description shown above is only about the preferred embodiments of the present invention and is not intended to limit the scope of the invention. For example, the priority callers are not limited to one set. For different scenarios, the device 100 may pre-record pre-recorded voice messages (and/or SMS) in associated with the different set of priority callers. The incoming call response module, as described in the embodiment above, may be integrated with the wireless communication device 180 if there is no space concern within the wireless communication device 180. In addition, following the step 490 or 492, the incoming call response module may also add a step of routing to a voicemail system for leaving a message by the caller. Accordingly, those skilled in the art should understand that the above details are only illustrated for exemplary purpose rather than limitation. Any equivalent variations or modifications without departing from the spirit disclosed by the present invention should be included in the appended claims.

What is claimed is:

1. A device for a wireless communication device for processing incoming calls, comprising:
a bus system;
a memory connected to the bus system, wherein the memory comprises a set of incoming call response instructions; and
a controller connected to the bus system, wherein the controller executes the set of incoming call response instructions, the incoming call response instructions comprising:
checking a scenario setting and a user preference;
responding, if a caller of an incoming call is a priority caller as defined in the user preference, with at least one of a pre-recorded answering voice and a pre-defined message indicated by the user preference and corresponding to the scenario setting, and
responding, if a caller of an incoming call is not a priority caller as defined in the user preference, with at least one of a standard and a default pre-recorded answering voice and pre-defined message.

2. The device according to claim 1, wherein the scenario setting includes at least one of the following: in a meeting, on a call, in class, on the go, and at client site.

3. The device according to claim 1, wherein the priority caller is classified by the identity of caller, the identity of the caller including: a boss, a friend, a colleague, and an identity defined by the user.

4. The device according to claim 1, further comprising a set of keys comprising a play key and a record key for the user to directly play and record at least one of voice messages and short message service (SMS).

5. The device according to claim 4, wherein said set of keys further comprises a plurality of keys for the user to directly select at least one of the pre-recorded voice message and the SMS for responding to the caller.

6. A computer program product for a wireless communication device for processing incoming calls, the computer program product comprising a computer readable storage medium having computer readable program code embodied therewith, the computer readable program code configured to:
communicate with a cell phone;
determine a caller associated with an incoming call on the cell phone;
determine a current scenario setting for a user of the wireless communication device;
determine a priority of the caller;
select a pre-defined message to play for the caller, wherein the pre-defined message is selected based on at least the current scenario setting and the priority of the caller.

7. The computer program product of claim 6, wherein the current scenario setting is defined by the user.

8. The computer program product of claim 6, wherein the current scenario setting is one of a plurality of scenario settings defined by a user preference.

9. The computer program product of claim 8, wherein the priority of the caller is one of a plurality of priorities defined by a user preference.

10. The computer program product of claim 6, further comprising selecting a default message in response to no pre-defined message existing for the current scenario setting and the priority of the caller.

11. The computer program product of claim 6, wherein the cell phone automatically routes the incoming call to the wireless communication device.

12. A method for a wireless communication device comprising memory to process incoming calls, the method comprising:
determining whether the wireless communication device is in an auto-reply mode;
in response to determining that the wireless communication device is in the auto-reply mode:
determining a caller associated with an incoming call;
determining a current scenario setting for a user of the wireless communication device;
determining a priority of the caller; and
selecting a pre-defined message to play for the caller in response to finding a pre-defined message that is associated with the current scenario setting and the priority of the caller.

13. The method of claim 12, further comprising, in response to determining that the wireless communication device is not in the auto-reply mode:
notifying the user of the wireless device of the incoming call and one or more of a number and caller identification associated with the incoming call;
in response to the user not answering the incoming call, routing the incoming call to a voicemail feature; and
in response to the user selecting a pre-defined message to play for the caller, playing the pre-defined message selected by the user.

14. The method of claim 13, wherein the user selects the pre-defined message to play for the caller using one or more buttons on the wireless communication device.

15. The method of claim 12, further comprising displaying on the wireless communication device, at least one of a phone number associated with the incoming call and an ID associated with the incoming call.
